(19) United States
(12) Patent Application Publication
(10) Pub. No.: US 2009/0248645 A1
(43) Pub. Date: Oct. 1, 2009

(54) DEVICE, METHOD AND COMPUTER READABLE MEDIUM FOR MANAGEMENT OF TIME-SERIES DATA

(75) Inventor: Kanae OGURA, Kakamigahara (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/413,542

(22) Filed: Mar. 28, 2009

(30) Foreign Application Priority Data
Mar. 28, 2008 (JP) 2008-088070

(51) Int. Cl. G06F 17/30

(52) U.S. Cl. 707/3; 707/E17.108

(57) ABSTRACT

There is provided a device for managing time-series data, comprising: a storage unit configured to store time-series data and related information; a designation unit configured to designate a time delimiting point to be set to the time-series data; a setting unit configured to set the time delimiting point to partial time-series data defined as a part of the time-series data; a display control unit configured to display a plurality of keywords in a predetermined displaying priority order based on the related information of the time-series data; a selection unit configured to select at least one keyword from among the plurality of keywords displayed by the display control unit; and an association control unit configured to store the selected at least one keyword while associating the selected at least one keyword with the partial time-series data specified by the time delimiting point set by the setting unit.

### CROSS-REFERENCE TO RELATED APPLICATION

This application claims priority under 35 U.S.C. § 119 from Japanese Patent Application No. 2008-088070, filed on Mar. 28, 2008. The entire subject matter of the application is incorporated herein by reference.

### BACKGROUND

1. Technical Field

Aspects of the present invention relate to a time-series data management device capable of setting a time delimiting point to the time-series data and associating a keyword with a part of time-series data specified by the time delimiting point.

2. Related Art

In general, a recording device for recording a moving image in a hard disk drive is able to set a time delimiting point to the recoded data of the moving image. Therefore, the recording device is able to start reproducing the moving image from the time delimiting point set to the recoded data. Such a function of the recording device is generally called “funding of the beginning”. It is desirable to set a time delimiting point not only to data of a type such as a moving image but also to time-series data in regard to management of such time-series data. For example, generally, a telephone conversation includes a plurality of topics. In this regard, recorded data of a telephone conversation can be managed easily by assigning time delimiting points to respective topics in one recorded data.

Japanese Patent Provisional Publication No. 2007-306340A (hereafter, referred to as JP2007-306340A) discloses a telephone device capable of recording a telephone conversation and setting an identification mark to a part of recorded data of one telephone conversation. The telephone device disclosed in JP2007-306340A stores a part of a telephone conversation with the party on the other side and identification information for discriminating a partial period in the entire telephone conversation from the other partial periods in the entire telephone conversation.

### SUMMARY

In this specification, a part of the time-series data specified by a time delimiting point is frequently referred to as “partial time-series data”. As described above, by storing a plurality of time delimiting points for one time-series data (e.g., one recorded data), a user is able to easily find the beginning of partial time-series data when the user uses the partial time-series data. However, even if the time delimiting point is assigned to the partial time-series data, the user is not able to recognize the topic of the partial time-series data. In this case, the user needs to recall the topic of the partial time-series data.

That is, when the user uses the recorded time-series data at a later date, the user needs to recall the topic (or contents) of desired partial recorded data by referring to the time delimiting point assigned to the partial recorded data. If the user forgets an assigned time delimiting point to desired partial recorded data, the user needs to repeat work for checking the beginning of the partial recorded data based on the time delimiting point.

Aspects of the present invention are advantageous in that a time-series data management device configured to enable a user to easily search for partial time-series data specified by a time delimiting point is provided.

According to an aspect of the invention, there is provided a device for managing time-series data, comprising: a storage unit configured to store time-series data and related information; a designation unit configured to designate a time delimiting point to be set to the time-series data; a setting unit configured to set the time delimiting point to partial time-series data defined as a part of the time-series data; a display control unit configured to display a plurality of keywords in a predetermined displaying priority order based on the related information of the time-series data; a selection unit configured to select at least one keyword from among the plurality of keywords displayed by the display control unit; and an association control unit configured to store the selected at least one keyword while associating the selected at least one keyword with the partial time-series data specified by the time delimiting point set by the setting unit.

Such a configuration makes it possible to easily search the partial time-series data and thereby to easily manage the time-series data. It becomes also possible to reduce the load on the user who designates a keyword to the partial time-series data specified by a time delimiting point.

According to another aspect of the invention, there is provided a method for managing time-series data, comprising the steps of: storing time-series data and related information; designating a time delimiting point to be set to the time-series data; setting the time delimiting point to partial time-series data defined as a part of the time-series data; displaying a plurality of keywords in a predetermined displaying priority order based on the related information of the time-series data; selecting at least one keyword from among the displayed plurality of keywords; and storing the selected at least one keyword while associating the selected at least one keyword with the partial time-series data specified by the time delimiting point.

Such a configuration makes it possible to easily search the partial time-series data and thereby to easily manage the time-series data. It becomes also possible to reduce the load on the user who designates a keyword to the partial time-series data specified by a time delimiting point.

According to another aspect of the invention, there is provided a computer readable medium having computer readable instruction stored thereon, which, when executed by a processor of device for managing time-series data, configures the processor to perform the steps of: storing time-series data and related information; designating a time delimiting point to be set to the time-series data; setting the time delimiting point to partial time-series data defined as a part of the time-series data; displaying a plurality of keywords in a predetermined displaying priority order based on the related information of the time-series data; selecting at least one keyword from among the displayed plurality of keywords; and storing the selected at least one keyword while associating the selected at least one keyword with the partial time-series data specified by the time delimiting point.

Such a configuration makes it possible to easily search the partial time-series data and thereby to easily manage the time-series data. It becomes also possible to reduce the load on the user who designates a keyword to the partial time-series data specified by a time delimiting point.

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

### BRIEF DESCRIPTION OF THE ACCOMPANYING DRAWINGS

FIG. 1 illustrates a system configuration and a block diagram of an MFD (Multi-Function Device) according to an embodiment.

FIG. 2 illustrates an example of a data structure of a database stored in the MFD.

FIGS. 3 to 5 illustrate a flowchart of a recording process executed by the MFD.

FIGS. 6 to 8 illustrate examples of a displayed screen during the recording process.

FIG. 9 illustrates an example of a data structure of the database when new recorded data is registered.

### DETAILED DESCRIPTION

Hereafter, an embodiment according to the invention will be described with reference to the accompanying drawings.

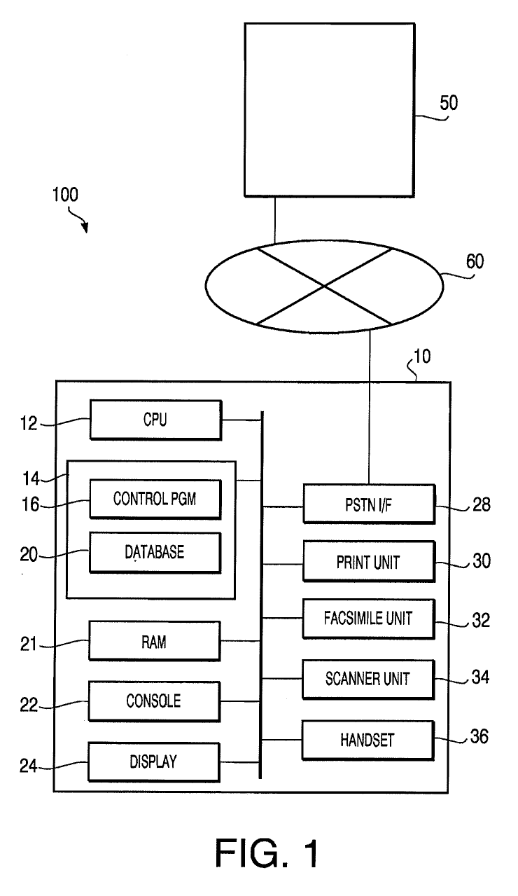

FIG. 1 illustrates a system configuration. In FIG. 1, a block diagram of an MFD (Multi-Function Device) 10 according to an embodiment is illustrated. In FIG. 1, another MFD 50 to which the MFD 10 is connected via a public network 60 is also illustrated.

As shown in FIG. 1, the MFD 10 includes a CPU 12, a storage unit 14, a RAM 21, a console 22, a display 24, a PSTN (Public Switched Telephone Networks) interface 28, a print unit 30, a facsimile unit 32, a scanner unit 34, and a handset 36. In FIG. 1, “I/F” means an interface, and “PGM” means a program.

The CPU 12 controls the functions of the MFD 10 in accordance with a control program 16 stored in the storage unit 14. Processes executed on the MFD 10 are based on the control program 16. The storage unit 14 also stores a database 20. The CPU 12 uses the RAM 21 to temporarily stores data to be transmitted or received data.

The console 22 is a hardware unit configured to accept user operations. The PSTN interface 28 is a hardware unit configured to interface the MFD 10 with the MFD 50 via the public network 60. Therefore, the MFD 10 is able to establish a connection with the MFD 50 via the public network 60. That is, two users of the MFDs 10 and 50 (i.e., a user of the MFD 10 and a user of the MFD 50) are able to perform communication (e.g., telephone communication) with each other.

The handset 36 is a hardware unit to perform telephone communication with the user of the MFD 50. The handset 36 accommodates a microphone and a speaker (not shown). The MFD 10 is also able to communicate with another MFD or a terminal via the Internet (not shown).

The print unit 30 is a hardware unit to execute the print function. The facsimile unit 32 is a hardware unit to execute the facsimile function. The scanner unit 34 is a hardware unit to execute the scanner function (i.e., the image reading function).

Since the MFD 50 has the same configuration as that of the MFD 10, explanations of the configuration of the MFD 50 will not be repeated. In the following, the system in which the MFD 10 and the MFD 50 are connected with each other via the public network 60 is referred to as a system 100.

The MFD 10 has a fiction of recording telephone communication and managing the recorded telephone communication. The recorded data is stored in the database 20 of the storage unit 14. That is, the recorded data is stored in the storage unit 14 as a file.

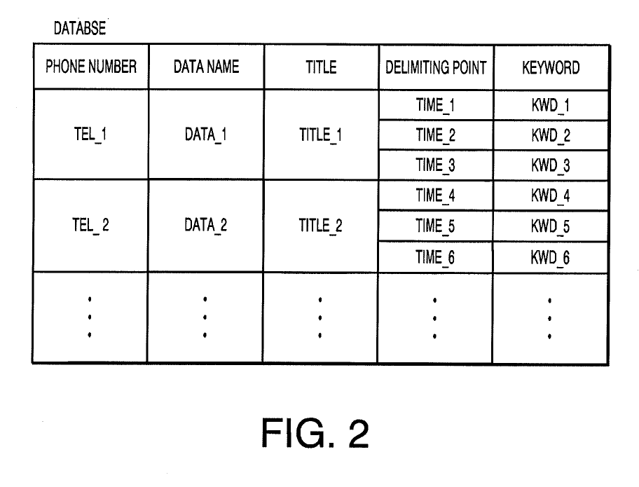

FIG. 2 illustrates an example of a data structure of the database 20. As shown in FIG. 2, the database 20 stores, as a record, a phone number (of a party on the other side), a data name (filename) of the recorded data, a title, a time delimiting point, and a keyword. That is, the MFD 10 stores a phone number (of a party on the other side), a data name (filename) of the recorded data, a title, a time delimiting point, and a keyword while associating a phone number (of a party on the other side), a data name (filename) of the recorded data, a title, a time delimiting point, and a keyword with respect to each other in the storage unit 14. In the following, if data is registered in the database 20, it means that the data is associated with data in a corresponding record. The title means a keyword related to the entire recorded data.

After recording the telephone communication, the MFD 10 creates a file of the recorded data and registers the file in the database 20. The MFD 10 registers a phone number of the party on the other side in the corresponding record containing the recorded data. That is, the MFD 10 stores the phone number of the party on the other side while associating the phone number with the recorded data. Further, the MFD 10 associates a title designated by the user with the entire recorded data, and registers the recorded data and the title in the database 20. The MFD 10 also has a function of registering the recorded data while associating a plurality of time delimiting points with the recorded data. The time delimiting point is data for specifying a time on the recorded data.

A part on the recorded data can be specified by two continuous time delimiting points. The MFD 10 also has a function registering the recorded data in the database 20 while associating a keyword with partial recorded data (i.e., a part of the recorded data) specified by time delimiting points.

In the example shown in FIG. 2, the recorded data “DATA_1” storing the telephone communication with the user “TEL_1” and the recorded data “DATA_2” storing the telephone communication with the user “TEL_2” are registered in the database 20. The recorded data “DATA_1” is associated with the title “TITLE_1”. In the recorded data “DATA_1”, three time delimiting points “TIME_1”, “TIME_2” and “TIME_3” are set. Although not shown in FIG. 2, a time delimiting point “TIME_0” is set at the top (at a top on the time base) of the recorded data “DATA_1”. The time delimiting point at the top of the recorded data is set automatically by the MFD 10 at the start of recording of telephone communication. “TIME_3” is a time delimiting point set at the end (i.e., at the end on the time base) of the recorded data “DATA_1”. The MFD 10 adds a last time delimiting point to the recorded data at the end of the telephone communication.

To the time delimiting point “TIME_1”, a keyword “KWD_1” is assigned. Similarly, keywords “KWD_2” and “KWD_3” are assigned to the delimiting points “TIME_1” and “TIME_2”, respectively. In other words, the partial recorded data specified by two time delimiting points “TIME_0” and “TIME_1” is associated with the keyword “KWD_1”, and the partial recorded data specified by two time delimiting points “TIME_1” and “TIME_2” is associated with the keyword “KWD_2”. Further, the partial recorded data specified by two time delimiting points “TIME_2” and “TIME_3” is associated with the keyword “KWD_3”. It is understood that keywords are assigned to the recorded data “DATA_2” in a similar manner.

The MFD 10 is able to set a time delimiting point designated by the user to the recorded data being recorded during the telephone communication while recording the telephone communication. Further, the MFD 10 is able to stores the time delimiting point and the keyword designated by the user while associating the time delimiting point and the keyword with each other. In the following, operation of the MFD 10 is explained for the case where the MFD 10 establishes a connection with the MFD 50 and the MFD 10 records the telephone communication with the user of the MFD 50.

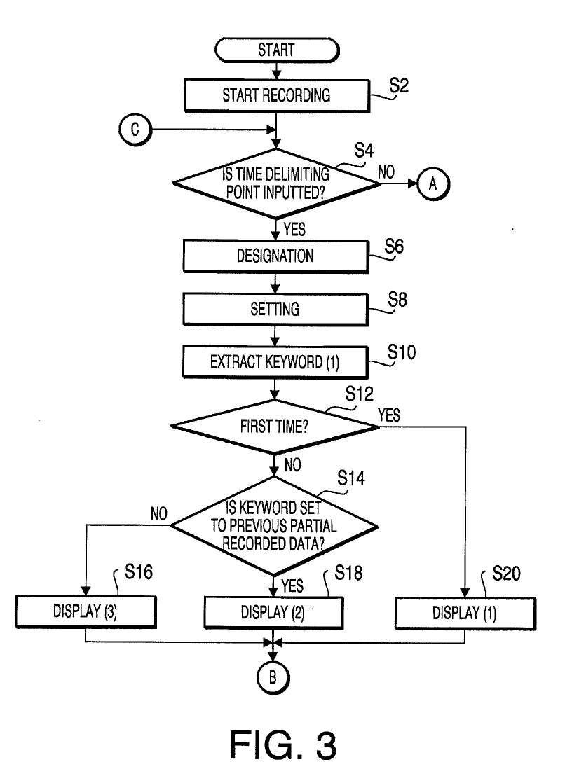

FIGS. 3 to 5 illustrate a flowchart of a recording process executed under control of the CPU 12 of the MFD 10.

When a connection is established, the MFD 10 starts recording a telephone communication (step S2). When the MFD 10 starts recording, the MFD 10 secures a new record for recorded data being recorded in the database 20. In this case, a phone number of the party on the other side (MFD 50) is recorded in the record. For example, a phone number of a destination may be registered when the MFD 10 makes a call. On the other hand, when receiving an incoming call, the MFD 10 may obtain the phone number of the party on the other side through a phone number notification service and register the obtained phone number in the database 20. The phone number is used as additional information concerning the recorded data.

When the user wants to set a time delimiting point during the telephone communication, the user inputs a time delimiting point by pressing a predetermined key on the console 22. That is, the MFD 10 accepts designation of the time delimiting point from the user (step S4). The MFD 10 designates an elapsed time from the start of recording as the time delimiting point (step S6). The MFD 10 is able to obtain such time information through an internal timer (not shown). The MFD 10 sets the designated time delimiting point (inputted by the user) to the recorded data being recorded (step S8). More specifically, the MFD 10 registers the designated time delimiting point to the record.

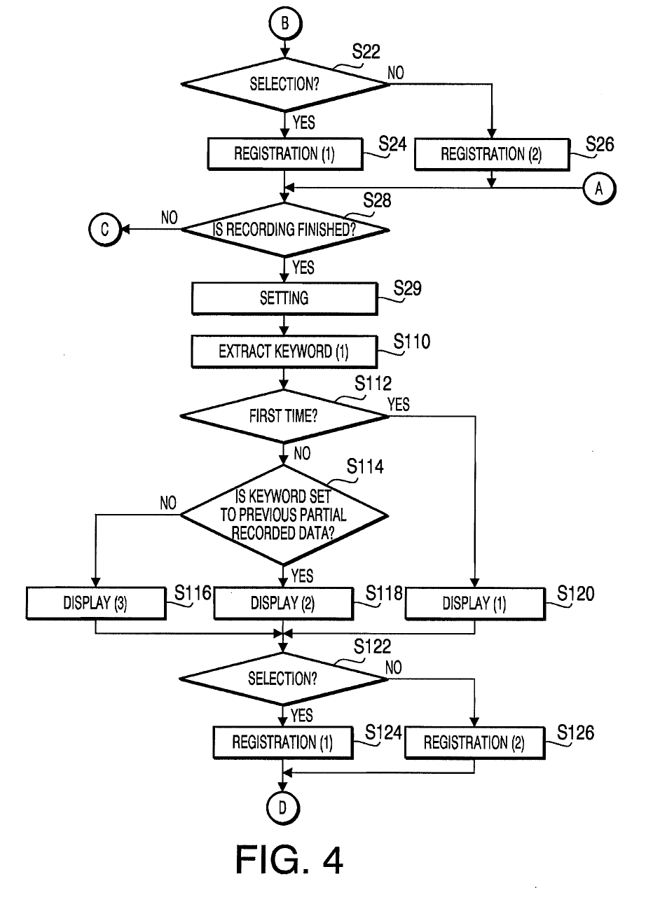

As shown in step S28 in FIG. 4, the MFD 10 accepts input of an time delimiting point until the recording is finished (S28: NO). In other words, the MFD 10 is able to repeatedly designate a plurality of time delimiting points with respect to one recorded data.

After setting the time delimiting point, the MFD 10 extracts candidates for a keyword to be associated with the time delimiting point from the database 20 (i.e., a keyword to be associated with the partial recorded data specified by the time delimiting point) (step S10). In FIG. 3, “KWD” means a keyword.

The keyword extraction in step S10 is executed as follows. The MFD 10 searches past records already registered in the database 20 for records having the same phone number as that of the party on the other side for which the connection is being currently established. Then, the MFD 10 extracts keywords registered in the searched records. That is, the MFD 10 extracts, from the database 20, keywords associated with the recorded data of the past telephone communication with the party on the other side for which the connection is being currently established. The keywords thus extracted are used as candidates for keywords to be assigned to the time delimiting point set in step S8.

Then, the MFD 10 displays the keywords extracted in step S10 (i.e., keyword candidates) in the display 24. In this case, the MFD 10 executes one of three types of displaying steps (S16, S18 and S20) of which displaying forms are different from each other, depending on the judging results in steps S12 and S14. The three types of displaying steps are explained below.

Display step (1): If the time delimiting point set in step S8 is the first time delimiting point which is designated first for the recorded data being recorded (S12: YES), the MFD 10 displays the keywords (candidates) in a predetermined displaying priority order (step S20). The predetermined displaying priority order may be an alphabetical order, the order of date when the keyword is associated with the recorded data, or the decreasing order of number of counts that the keyword is associated with the recorded data. The MFD 10 does nor regard the time delimiting point automatically set at the top of the recoded data as the first time delimiting point in step S12 because the time delimiting point automatically set at the top of the recoded data is not the time delimiting point designated in step S6.

Displaying step (2): If the time delimiting point set in step S8 is the second time or later time delimiting point designated for the recorded data for the second time or later (S12: NO), and the partial recorded data specified by the previous time delimiting point has been associated with a keyword (S14: YES) (hereafter, such a condition is referred to as an associated condition), the MFD 10 displays the keywords in the displaying form different from the previous displaying form (step S118). In other words, the displaying step (2) is executed if the associated condition is satisfied. In this case, the MFD 10 displays the same keyword that has been associated with the previous partial recorded data, in a different displaying form (step S18).

In step S18, the MFD 10 displays a keyword equal to the keyword which has been registered in the previous execution of step S24 while lowering the priority level. More specifically, the MFD 10 has stored the displaying priority order in the previous execution of step S16, S18 or S20. Further, the MFD 10 has stored the selected keyword (i.e., the keyword associated with the partial recorded data specified by the time delimiting point) which has selected in the previous execution of step S22 following the previous execution of step S16, S18 or S20. For this time around execution of the displaying step S18, the MFD 10 sets the displaying priory level of the previously selected keyword to a level lower than the stored displaying priority level stored in the previous execution of the displaying step.

Displaying step (3): If the time delimiting point set in step S8 is the second time or later time delimiting point designated for the recorded data for the second time or later (S12: NO), and no keyword has been associated with the partial recorded data specified by the previous time delimiting point (S14: NO) (i.e., If the associated condition is not satisfied), the MFD 10 displays the keyword in the same displaying priority level as the displaying priority level of the keyword in the previous execution of the displaying step (step S16).

Even if the designation of the time delimiting point is not the first time, the MFD 10 displays the keyword in the same displaying form as that in step S20 as long as no keyword has been registered for the recorded data. For example, if the time delimiting point has been set three times and no keyword has been set in the first and second time executions of designation of time delimiting points, the MFD 10 may display the keyword as follows. As in the case of the displaying step (1), the MFD 10 displays the keyword in the same displaying form as that used when the time delimiting point is designated first, without lowering the displaying priority level for the keyword. If the keyword has been registered for the first time designation of the time delimiting point, the keyword designated for the second time is displayed in the displaying form in which the displaying priority level of the keyword is lowered. If no keyword is selected for the secondly designated time delimiting point, the keyword for the time designation of the time delimiting point is displayed in the same displaying form as that used for the second time designation of the time delimiting point.

The judgment in steps S12 and S14 can be expressed as the judgment for branching concerning the associated condition. In summary, in the judgment in steps S12 and S114, the MFD 10 judges whether the associated condition (indicating that if another time delimiting point has been set when the time delimiting point is designated in step S6 (S12: NO) and the keyword selected in step S22 has been associated with the partial recorded data specified by the another time delimiting point in step S24) is satisfied.

As described above, the MFD 10 is able to designate time delimiting points for one recorded data. That is, steps S4 to S28 can be executed repeatedly. In the keyword extraction in step S10, the keywords are extracted based on the phone number of the MFD 50 (i.e. the part on the other side for which the connection is being established currently). Therefore, it becomes possible to extract the same keywords for each execution of designation of the time delimiting point. When the displaying step (S16, S18 or S20) is executed repeatedly, the same keyword is displayed in the different displaying form.

Referring back to FIG. 4, the user is able to designate a desired keyword to be associated with the time delimiting point from among the displayed keywords (keyword candidates). That is, the MFD 10 selects the keyword designated by the user from among the displayed keywords (step S22). In this case, the user is allowed to more than one keyword. In other words, the MFD 10 selects at least one keyword from among the displayed keywords.

When the MFD 10 selects the keyword (S22: YES), the MFD 10 registers the selected keyword in the database 20 while associating the selected keyword with the time delimiting point (step S24). That is, a new record is secured in step S2, a time delimiting point is set to the new record in step S8, and a keyword is associated with the newly set time delimiting point in step S24. The keyword associated with the time delimiting point means the keyword associated with the partial recorded data specified by the time delimiting point.

If desirable keywords are not displayed, the user is allowed not to select the keyword. That is, there is a case where keyword selection is not performed (S22: NO). In such a case, the MFD 10 registers a predetermined keyword in the database 20 while associating the predetermined keyword with the time delimiting point (step S26).

After registration of the keyword is finished (S24 or S26), the MFD 10 repeats the above described steps until the recordation is finished (S28: NO).

When the recording is finished (S28: YES). The MFD 10 automatically sets a time delimiting point at the end of the recorded data (step S29). Then, the MFD 10 repeats steps S12 to S26 (step S110 to S126). Since steps S110 to S126 are the same as steps S12 to S26, explanations of the steps S110 to S126 will not be repeated.

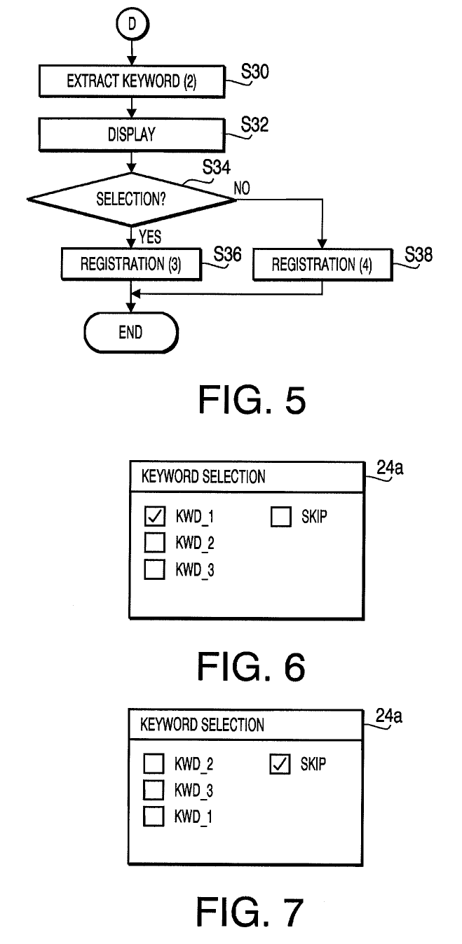

Next, the MFD 10 executes again the keyword extraction process in step S30 (see FIG. 5). The keyword extraction process in step S30 is slightly different from the keyword extraction process in step S10. That is, in step S10, the MFD 10 extracts the keywords associated with the partial recorded data. By contrast, in step S30, the MFD 10 extracts the keyword associated with the entire recorded data. In this case, the MFD 10 searches the past records already registered in the database 20 for a record having the same phone number as that of the party on the other side for which the connected is being currently established, and extracts the keywords registered as titles in the searched records.

Next, the MFD 10 displays the keywords extracted in step S30 on the display 24. That is, the MFD 10 displays the keyword which is different from the keywords displayed when the recording is in progress. The user selects a keyword to be associated with the entire recorded data from among the keywords displayed in step S32 (step S34). The MFD 10 identifies the keyword selected by the user. In other words, the MFD 10 selects one keyword from among the displayed keywords. The MFD 10 registers the selected keyword in the database 20 as a keyword (i.e., a title) to be associated with the entire recorded data (step S36).

After displaying the keyword in step S32, the user may deny selection of the keyword (S34: NO). If the user does not select the keyword (i.e., the MFD 10 does not select the keyword), the MFD 10 registers a predetermined keyword (step S38). Thus, a plurality of time delimiting points, keywords for the time delimiting points, and the title are associated with the recorded data. The “title” means a keyword associated with the entire recorded data.

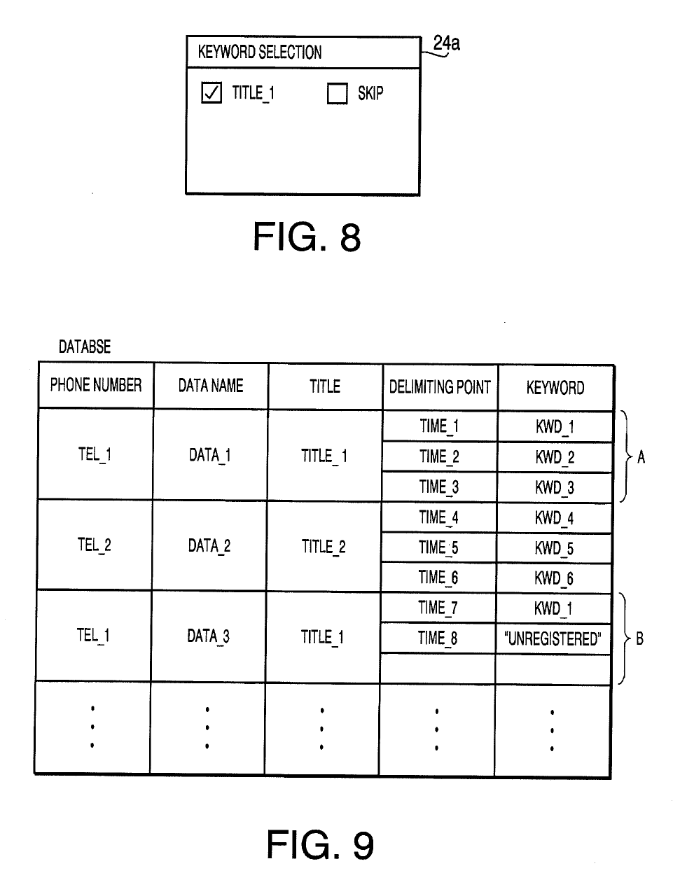

In the following, examples of displaying processed are explained with reference to FIG. 2 (database 20) and FIGS. 6 to 9. In the following, it is assumed that the MFD 10 establishes a connection with a device having the phone number “TEL_1”, and the MFD 10 executes the recordation of the phone communication with the device of “TEL_1”. The newly created recorded data is called “DATA_3”. FIGS. 6 to 8 are examples displayed on a screen 24a of the display 24. FIG. 6 illustrates a screen presented in step S20 which is executed when the time delimiting point is ser first. FIG. 7 illustrates a screen presented in step S18 which is executed when the associated condition is satisfied. FIG. 8 illustrates a screen presented in step S32 which is executed when the recording is finished. FIG. 9 illustrates the database 20 in which new recorded data is added to a new record (see a symbol “B” in FIG. 9).

When the recording is started on the MFD 10, the user inputs the first time delimiting point (S4). The MFD 10 sets the inputted time delimiting point to the new record in the database 20 (S8). The “TIME_7” corresponds to the first time delimiting point. Then, the MFD 10 searches the database 20 for the past records having the phone number “TEL_1” (see a symbol “A” in FIG. 9), and extracts the keywords set to the searched records (S10). In this case, the keywords “KWD_1”, “KWd_2” and “KWD_3” are extracted (see the symbol “A” in FIG. 9).

Next, the MFD 10 displays the extracted keywords (S20). In this case, a screen shown in FIG. 6 is displayed in the screen 24a. As shown in FIG. 6, the “KWD_1”, “KWD_2” and “KWD_3” are displayed in this order from the top of the screen 24a. The MFD 10 stores the displaying priority order for the keyword. On the screen 24a, a string “SKIP” is also displayed. In FIG. 6, a rectangular check box is also displayed for each item. The user is able to select a desired keyword or a string “SKIP” by setting a desired check box (of a desired keyword or a string “SKIP”) to ON. In FIG. 6, the keyword “KWD_1” is selected by the user. In this case, the MFD 10 selects the keyword “KWD_1”.

The MFD 10 stores the selected keyword. The MFD 10 registers the selected keyword in a new record (step S24). That is, the MFD 10 associated the selected keyword with the partial recorded data specified by the time delimiting point. In FIG. 9, the keyword “KWD_1” has been associated with the time delimiting point “TIME_7”. If the string “SKIP” is selected, the MFD 10 automatically registers a predetermined keyword (“Unregistered”). The string “Unregistered” may be stored in advance in the storage unit 14. That is, in this case, the MFD 10 reads the string “Unregistered” from the storage unit 14 and registers the “Unregistered”.

The user inputs time delimiting point for the second time (step S4). Then, the MFD 10 sets the time delimiting point to a new record in the database 20 (step S8). In FIG. 9, “TIME_2” is the time delimiting point which has set for the second time. The MFD 10 searches the database 20 for a past record having the phone number “TEL_1” (see the symbol A in FIG. 9), and extracts keyword set for the searched record (step S10). In this case, “KWD_1”, “KWD_2” and “KWD_3” are extracted.

When the keywords are displayed for the second time, the MFD 10 displays the keyword “KWD_1” which has been selected in the previous selection of the keyword at the lowest position (step S18). In this case, onscreen representation is made on the screen 24a as shown in FIG. 7. As shown in FIG. 7, “KWD_2”, “KWD_3” and “KWD_1” are displayed in this order from the top of the screen 24a. That is, the MFD 10 displays the keywords such that the priority level of the keyword which has been already associated with the time delimiting point is lowered. If the user selects the string “SKIP”, the MFD 10 stores the predetermined string “Unregistered” while associating the predetermined string “Unregistered” with the new time delimiting point “TIME_8”. FIG. 9 illustrates the state where the keyword “Unregistered” is associated with the time delimiting point “TIME_8”.

When the recording is finished (S28: YES), the MFD 10 searches for a past record (see the symbol A in FIG. 9) having the phone number “TEL_1”, and extracts the title (i.e., the keyword associated with the entire recorded data) assigned to the searched record (step S30). In this case, the keyword “TITLE_1” is extracted (see the symbol A in FIG. 9). The MFD 10 displays the extracted keyword (step S32). In this case, onscreen representation is made as shown in FIG. 8. That is, in the state where the recording is finished, the MFD 10 displays the keyword different from the keywords displayed during execution of the recording. For example, when the user selects “TITLE_1”, the MFD 10 associates the keyword “TITLE_1” with the recorded data “DATA_3”, and registers the keyword “TITLE_1” in the database 20 (step S36). FIG. 9 illustrates the state where the title (keyword) “TITLE_1” is associated with the new recorded data “DATA_3”.

In the following, advantages achieved by the above described embodiment are explained.

(1) When the MFD 10 designates a new time delimiting point, the MFD 10 displays the keyword which has been selected in the previous designation of the keyword, at the lowest position on the screen 24a. In other words, the MFD 10 displays the keyword which has been selected in the previous selection, while lowering the displaying priority level of the keyword. The MFD 10 displays the keywords such that the keyword which has not been selected can be displayed at conspicuous portions on the screen in comparison with the keyword which has been selected. By thus displaying the keywords, the MFD 10 enables the user to easily select the keyword which has not been selected. That is, the user is able to easily find the keyword which has not been selected.

The MFD 10 is able to reduce the load on the user assigning the different keywords to the plurality of time delimiting points set for one recorded data. In place of displaying the keyword which has been selected at the lowest position on the screen, the MFD 10 may display the keyword which has been selected in a lower intensity. Alternatively, the MFD 10 may display the keyword which has been selected in a smaller size.

(2) The MFD 10 extracts and displays the keyword associated with the past recorded data (i.e., past partial recorded data). Therefore, it becomes possible to associate the same keyword as the keyword of the past partial recorded data with the new partial recorded data. By thus using the same keyword, the user is able to collectively manage the new partial recorded data and the past partial recorded data. The MFD 10 may displays words contained in the new partial recorded data, as keywords to be selected. In this case, the MFD 10 is also able to display the keyword representing the contents of the new recorded data. With this configuration, the user is able to select the keyword representing the contents in the new partial recorded data.

(4) The MFD 10 associates the predetermined keyword with the designated time delimiting point in response to a fact that the time delimiting point is designated (S8) and the user decided not to select the keyword (S22: NO and S26). Therefore, it becomes possible to distinguish the partial recorded data with which the desired keyword is associated from the partial recorded data with which no keyword is selected by the user. The MFD 10 may assign an identification to the designated time delimiting point in response to a fact that the user decided not to select the keyword.

(5) When the recording is finished, the MFD 10 displays the keyword (title) associated with the entire past recorded data. Therefore, when the recording is finished, the user is able to select the keyword for specifying the entire recorded data.

Although the present invention has been described in considerable detail with reference to certain preferred embodiments thereof, other embodiments are possible.

The data to be managed by the MFD 10 is not limited to the recorded data. For example, moving image data or measurement data may be managed on the MFD 10 as time-series data. By selecting the registered keyword, the MFD 10 may reproduce the partial recorded data associated with the registered keyword.

In the above described embodiment, the user selects a keyword to be associated with a time delimiting point from among the displayed keywords. However, the MFD may be configured to allow the user to directly input a keyword to be associated with a time delimiting point, for example, in step S22 of FIG. 4.

What is claimed is:

1. A device for managing time-series data, comprising:
a storage unit configured to store time-series data and related information;
a designation unit configured to designate a time delimiting point to be set to the time-series data;
a setting unit configured to set the time delimiting point to partial time-series data defined as a part of the time-series data;
a display control unit configured to display a plurality of keywords in a predetermined displaying priority order based on the related information of the time-series data;
a selection unit configured to select at least one keyword from among the plurality of keywords displayed by the display control unit; and
an association control unit configured to store the selected at least one keyword while associating the selected at least one keyword with the partial time-series data specified by the time delimiting point set by the setting unit.

2. The device according to claim 1,
wherein:
the designation unit is configured to designate a plurality of time delimiting points to be set to the time-series data; and
the display control unit is configured to display the plurality of keywords each time a time delimiting point of the plurality of time delimiting points is designated through the designation unit such that a displaying priority level of a keyword which has been associated with the time-series data in a previous execution of displaying of the plurality of keywords is lowered.

3. The device according to claim 2,
further comprising a judgment unit configured such that when the time delimiting point is designated through the designation unit, the judgment unit judges whether a keyword selected through the selection unit has been associated with partial time-series data specified by another time delimiting point already associated with the time-series data,
wherein the display control unit is configured to:
display the keyword which has been associated with the time-series data in the previous-execution of displaying of the plurality of keywords such that the displaying priority level of the keyword is lowered if the judgment unit judges that the keyword has been associated with the partial time-series data specified by another time delimiting point; and
display the plurality of keywords in a displaying priority order defined in previous designation of the time delimiting point through the designation unit if the judgment unit judges that the keyword has not been associated with the partial time-series data specified by another time delimiting point.

4. The device according to claim 1, wherein the display control unit is configured to display a plurality of words extracted from the time-series data as the plurality of keywords.

5. The device according to claim 1, wherein the display control unit is configured to display the plurality of keywords which have been associated with the partial time-series data of past time-series data stored in the storage unit.

6. The device according to claim 1, wherein the association unit is configured such that if the time delimiting point is designated through the designation unit but no keyword is selected through the selection unit, the association unit associates a predetermined keyword with the partial time-series data specified by the time delimiting point set by the setting unit.

7. The device according to claim 1, wherein the association unit is configured such that if the time delimiting point is designated through the designation unit but no keyword is selected through the selection unit, the association unit associates an identification indicating that no keyword is selected with the partial time-series data specified by the time delimiting point set by the setting unit.

8. The device according to claim 1,
further comprising:
a telephone unit having a telephone function; and
a recording unit configured to record a telephone communication,
wherein:
the time-series data includes recorded data recorded by the recording unit;
the display control unit displays the plurality of keywords at a time of completion of recordation by the recording unit; and
the association unit is configured to associate the keyword selected through the selection unit at the time of completion of recordation with the entire recorded data.

9. The device according to claim 8,
wherein:
the partial time-series data is partial recorded data specified by the time delimiting point set to the recorded data;
the display control unit is configured to:
display the plurality of keywords which have been associated with partial recorded data of another recorded data which has already been recorded by the recording unit in response to designation of the time delimiting point through the designation unit during recordation of the recorded data; and
display the keyword which have been associated with another recorded data which has already been recorded by the recording unit.

10. The device according to claim 8, wherein the display control unit displays the plurality f keywords which have been associated with past recorded data of the telephone communication with a party on the other side having a same phone number as a phone number of a current party on the other side.

11. A method for managing time-series data, comprising the steps of:
storing time-series data and related information;
designating a time delimiting point to be set to the time-series data;
setting the time delimiting point to partial time-series data defined as a part of the time-series data;
displaying a plurality of keywords in a predetermined displaying priority order based on the related information of the time-series data;
selecting at least one keyword from among the displayed plurality of keywords; and
storing the selected at least one keyword while associating the selected at least one keyword with the partial time-series data specified by the time delimiting point.

12. The method according to claim 11,
wherein:
in the step of designating, a plurality of time delimiting points to be set to the time-series data are designated; and
in the step of displaying, the plurality of keywords are displayed each time a time delimiting point of the plurality of time delimiting points is designated such that a displaying priority level of a keyword which has been associated with the time-series data in a previous execution of displaying of the plurality of keywords is lowered.

13. The method according to claim 12, further comprising the step of judging whether a selected keyword has been associated with partial time-series data specified by another time delimiting point already associated with the time-series data when the time delimiting point is designated,
wherein the step of displaying further comprises the steps of:
displaying the keyword which has been associated with the time-series data in the previous-execution of displaying of the plurality of keywords such that the displaying priority level of the keyword is lowered if it is judged that the keyword has been associated with the partial time-series data specified by another time delimiting point; and
displaying the plurality of keywords in a displaying priority order defined in previous designation of the time delimiting point if it is judged that the keyword has not been associated with the partial time-series data specified by another time delimiting point.

14. The method according to claim 11, wherein in the step of displaying, a plurality of words extracted from the time-series data are displayed as the plurality of keywords.

15. The method according to claim 11, wherein in the step of displaying, the plurality of keywords which have been associated with the partial time-series data of past time-series data are displayed.

16. A computer readable medium having computer readable instruction stored thereon, which, when executed by a processor of device for managing time-series data, configures the processor to perform the steps of:
storing time-series data and related information;
designating a time delimiting point to be set to the time-series data;
setting the time delimiting point to partial time-series data defined as a part of the time-series data;
displaying a plurality of keywords in a predetermined displaying priority order based on the related information of the time-series data;
selecting at least one keyword from among the displayed plurality of keywords; and
storing the selected at least one keyword while associating the selected at least one keyword with the partial time-series data specified by the time delimiting point.

17. The computer readable medium according to claim 16,
wherein:
in the step of designating, a plurality of time delimiting points to be set to the time-series data are designated; and
in the step of displaying, the plurality of keywords are displayed each time a time delimiting point of the plurality of time delimiting points is designated such that a displaying priority level of a keyword which has been associated with the time-series data in a previous execution of displaying of the plurality of keywords is lowered.

18. The computer readable medium according to claim 17, the method further comprising the step of judging whether a selected keyword has been associated with partial time-series data specified by another time delimiting point already associated with the time-series data when the time delimiting point is designated,
wherein the step of displaying further comprises the steps of:
displaying the keyword which has been associated with the time-series data in the previous-execution of displaying of the plurality of keywords such that the displaying priority level of the keyword is lowered if it is judged that the keyword has been associated with the partial time-series data specified by another time delimiting point; and
displaying the plurality of keywords in a displaying priority order defined in previous designation of the time delimiting point if it is judged that the keyword has not been associated with the partial time-series data specified by another time delimiting point.

19. The computer readable medium according to claim 16, wherein in the step of displaying, a plurality of words extracted from the time-series data are displayed as the plurality of keywords.

20. The computer readable medium according to claim 16, wherein in the step of displaying, the plurality of keywords which have been associated with the partial time-series data of past time-series data are displayed.
